(19) United States
(12) Patent Application Publication
(10) Pub. No.: US 2012/0193827 A1
(43) Pub. Date: Aug. 2, 2012

(54) Microporous Film

(75) Inventor: Ramasubramanian Narayanan, Tiruvanmiyur (IN)

(73) Assignee: Ticona LLC, Florence, KY (US)

(21) Appl. No.: 13/334,852

(22) Filed: Dec. 22, 2011

Related U.S. Application Data
(60) Provisional application No. 61/426,850, filed on Dec. 23, 2010.

(51) Int. Cl. B29C 67/20

(52) U.S. Cl. 264/49

(57) ABSTRACT

A microporous film is described made from a polyacetal polymer. in one embodiment, the microporous film is formed from a composition comprising a polyacetal copolymer combined with an inorganic filler and a plasticizer. The polymer composition is extruded or molded into a sheet. The sheet is then passed through an extraction medium in order to remove a portion of the plasticizer. The extraction medium is then removed from the sheet.

### RELATED APPLICATIONS

The present application is based upon and claims priority to United States Provisional Patent Application No. 61/426,850, filed on Dec. 23, 2010.

### BACKGROUND

Polyacetal resins are chemically very stable however films therefrom lack surface activity. This, coupled with the fact that there are few solvents available which has good affinity to such resin, has virtually defied the possibility of subjecting molded products or thin films of such resin to such surface decoration as plating, printing, coating, or deposition, or surface bonding with an adhesive. Special modification efforts are needed, such as generating surface features such that sufficient anchoring of applied coatings and the like may adhere. It is known from U.S. Pat. No. 4,836,889 that a polyacetal resin blended with one or more kinds of fine powdery metallic oxides can be etched with an acidic solution e.g., sulfuric acid, hydrochloric acid, and phosphoric acid to render the surface with enhanced adherence properties. Such acidic treatments are difficult to control, and are degradative agents, not to mention the special handling precautions and waste effluent.

Special primers have been disclosed which exhibits adhesion to polyacetal, as shown in U.S. Pat. No. 4,971,727 in which a conductive primer surfacer paint comprises: (A) Polyurethane base resin, (B) Opening ring expansive spiro-ortho-ester base resin, (C) Cellulose derivative, (D) Hydroxyl group containing surface active agent, and (E) Conductive material. Such a primer limits the potential for coatings on the treated surface. It would be industrially important to eliminate the use of primers entirely in respect of polyoxymethylene substrates for introducing printing inks, coatings, adhesives and the like.

In the treatment of polyacetal according to Celanese U.S. Pat. No. 3,920,785 the porosity of an open-celled microporous polymer film is enhanced by cold stretching a non-porous, crystalline, elastic film of polyacetal at a temperature below the temperature at which the film begins to melt, until porous surface regions perpendicular to the stretch direction are formed, followed by hot stretching the film at a film temperature in the range of the melt or fusion temperature until pore spaces elongated parallel to the stretch direction are formed. Typically a stretch ratio of 10 to 300 percent of the original length of the elastic film is necessary. However, certain polyacetal polymers having insufficient melt strength to be handled as thin films by extrusion followed by stretching under tension. Moreover, heating certain microporous polyacetal films under tension can give rise to tearing of the film. Polyacetal films which can be rendered microporous and which can withstand calendaring, as well as cold and hot stretching under tension would be industrially important.

In the treatment of plasticizer-soaked inorganic filler containing polyacetal film utilizing steam for extraction of plasticizer and/or filler particles from the film surface, certain types of polyacetal films tend to disintegrate on contact with steam. Polyacetal films which do not disintegrate on contact with steam would be industrially important.

### SUMMARY OF THE INVENTION

The invention is directed to polyacetal copolymer microporous films. Such films formed with polyacetal copolymers having a certain range of Melt Index can be formed without tearing, disintegration, as is observed in the use of homopolymer polyacetal and other problems. As used herein, the term “copolymer” is intended to encompass structural units derived from trioxane and cyclic formals or their functionalized derivatives. Thus, the term “copolymer” as used herein is intended to encompass terpolymers, tetrapolymers, and the like that include structural units in the polymer chain derived from trioxane and cyclic formals or their functionalized derivatives in addition to other units, if present during polymerization. For instance, other units can be derived from trioxane or a mixture of trioxane and dioxolane and cyclic formals, e.g., cyclic ether and cyclic acetal monomers.

Specifically polyoxymethylene copolymers treated in the manner according to the invention will have a Melt Flow Rate or melt index (M.I.) of from about 0.5 to 3.5, and a number average molecular weight of preferably in a range of from 50,000 to 200,000 preferably 70,000 ₜo 100,000. The copolymers are substantially linear (<1 branch per 100 repeating units) and have one or more types of C2 ether segments or polyether segments in the molecular chain. Such copolymers are generally produced by copolymerizing a cyclic ether with at least one alkylene oxide, or cyclic acetal e.g. dioxolane. The polyoxymethylene copolymer can be manufactured by the copolymerization of trioxane with as little as 0.002 to as much as 10 parts per 100 parts of trioxane of cyclic acetal containing at least one O(CH2)n group where n>1. In general, the polyoxymethylene copolymer can include 90 mol-% and higher of —CH2O-repeat units.

The following U.S. Patents are hereby incorporated by reference: U.S. Pat. Nos. 4,833,172, 4,861,644, 4,877,679, 4,892,779, 4,972,802, 4,937,115, 4,957,787, 4,959,208, 5,032,450, 5,035,886, 5,047,283, 5,071,645, 5,114,438, 5,196,262, 5,326,391 and 5,583,171.

### Polyoxymethylene Copolymers

The copolymerization of monomers to form polyoxymethylene is well known. Polymerization is generally initiated by cationic initiator, such as organic or inorganic acids, acid halides, and Lewis acids. One example of the latter is boron fluoride and its coordination complexes with organic compounds in which oxygen or sulfur is the donor atom. The coordination complexes of boron trifluoride may, for example, be a complex with a phenol, an ether, an ester, or a dialkyl sulfide. Boron trifluoride etherate (BF3·Et2O) is one preferred coordination complex useful in the cationic copolymerization processes. Alternately, gaseous BF3 may be employed as the polymerization initiator. Preferredly the catalyst concentration can range from about 0.001 to about 0.1 weight percent, based on the total weight of the monomer mixture. A chain transfer agent such as methylal, butylal, mixtures of acetals, esters or alcohols including methyl formate, methanol, and so forth may be used.

The polyoxymethylene polymer backbone optionally can include functional groups. For instance, a polyoxymethylene copolymer can be formed to include terminal functional groups, and for side or pendant functional groups, such as hydroxyl groups, so as to further improve the adhesion of the polymer to inks, coatings and the like. In one embodiment, terminal groups can also provide binding sites for formation of bonds with optional functional additives.

According to one embodiment, a polyoxymethylene copolymer can be formed to include a relatively high number of terminal hydroxyl groups on the copolymer. For example, the polyoxymethylene copolymer can have terminal hydroxyl groups, for example hydroxyethylene groups and/or hydroxyl groups, in greater than about 50% of all the terminal sites on the polymer, which includes both polymer end groups and terminal side, or pendant, groups. For instance, greater than about 70%, greater than about 80%, or greater than about 85% of the terminal groups on the polyoxymethylene copolymer may be hydroxyl groups, based on the total number of terminal groups present. In one embodiment, up to about 90%, or up to about 85% of the terminal groups on the polyoxymethylene copolymer may be hydroxyl groups. In one preferred embodiment, a polyoxymethylene copolymer can include up to about 20 hydroxyl groups per polymer chain, for instance, between about 15 and about 20 hydroxyl groups per chain.

The polyoxymethylene copolymer can have a content of terminal hydroxyl groups of at least about 5 mmol/kg, such as at least about 10 mmol/kg, such as at least about 15 mmol/kg. For example, the terminal hydroxyl group content ranges from about 18 to about 50 mmol/kg.

A preferred polyoxymethylene copolymer can be formed to include a high percentage of terminal hydroxyl groups through selection of the chain transfer agent used during polymerization. For instance, a glycol chain transfer agent such as ethylene glycol, diethylene glycol, mixtures of glycols, and the like can be used in a copolymerization of trioxane with a cyclic acetal containing at least one O(CH2)n group where n>1. According to this embodiment, greater than about 80%, for instance greater than about 85% of the terminal end groups on the formed polyoxymethylene copolymer can be ethoxyhydroxy or —OCH2CH2OH (—C2OH) end groups. This type of polyoxymethylene copolymer (i.e., trioxane copolymerized with a cyclic acetal in the presence of an ethylene glycol chain transfer agent) is referred to throughout this disclosure as polyoxymethylene-OH.

A polyoxymethylene copolymer can be formed from polymerization of one or more monomers that can produce on the copolymer various terminal groups that can provide desirable characteristics to the resulting polymer film which promotes further adhesion of coatings thereto. For example, a copolymer can be formed so as to include terminal and/or pendant groups including, without limitation, alkoxy groups, formate groups, acetate groups and/or aldehyde groups. The terminal groups can be functional as formed, and can provide bonding sites for bonding with one or more components. Alternatively, the formed copolymer can be further treated to form functional groups. For example, following formation, the copolymer can be subjected to hydrolysis to form the desired terminal groups on the copolymer.

Any of a variety of different monomers can be copolymerized with one or more other polyoxymethylene -forming monomers, e.g., trioxane. Monomers can include, without limitation, cyclic formals having pendant acrylate or substituted acrylate ester groups, cyclic ethers, cyclic acetals, and so forth. By way of example, trioxane can be copolymerized with 1,2,6-hexanetriol formal or its ester derivatives, as described in U.S. Pat. No. 4,975,518 to Broussard, et al.; ester derivatives glycerol formal, as described in U.S. Pat. No. 4,975,519 to Yang, et al.; glycidyl ester derivatives, as described in U.S. Pat. No. 4,983,708 to Yang, et al.; and trimethylolpropane formal derivatives, as described in U.S. Pat. No. 5,004,798 to Broussard, et al. (all patents are incorporated herein by reference). Monomers can include, without limitation, isomers of glycerol formal, such as glycerol formal acetate (GFA), glycerol formal methacrylate, glycerol formal crotanate, and glycerol formal chloracetate; glycerol formal formate (GFF); 1,2,6-hexanetriol formal acetate; glycidyl acrylate; 5-ethyl-5-hydroxymethyl-1,3-dioxane (EHMDO); EHMDO ester of acetic acid; EHMDO ester of acrylic acid; EHMDO ester of 3-choro-propanoic acid; EHMDO ester of 2-methylacrylic acid; EHMDO ester of 3-methylacrylic acid; EHMDO ester of undedocenoic acid; EHMDO ester of cinnamic acid; EHMDO ester of 3,3-dimethylacrylic acid; and so forth.

A monomer can include a terminal group that is much less reactive during polymerization as compared to the formal group itself or the trioxane, e.g., an ester group, a formate group, or an acetate group. Accordingly, the terminal group can remain unreacted during polymerization to form an essentially linear polymer with side chain functionality. This side chain functionality can be suitable for use as is or, alternatively, can be hydrolyzed following polymerization to yield pendant hydroxyl functional groups. Hydrolysis following polymerization can also remove unstable hemiacetal end groups and improve the stability of the resulting copolymers.

In one preferred embodiment, a polyoxymethylene copolymer can be formed via the copolymerization of trioxane with between about 0.2 and about 6 parts by weight of dioxolane per 100 parts trioxane using methylal as a chain transfer agent.

Multiple monomers may be employed in forming the copolymers so as to form tri- or tetra-polymers. For instance, a trioxane can be polymerized with a mixture of dioxolane and one or more cyclic formals, per above. Additional monomers as are generally known in the art can be incorporated. Exemplary monomers can include ethylene oxide, 1,3-dioxolane, 1,3-dioxepane, 1,3- dioxep-5-ene, 1,3,5-trioxepane, and the like.

The polymerization can be carried out as precipitation polymerization or in the melt. By a suitable choice of the polymerization parameters, such as duration of polymerization or amount of chain transfer agent, the molecular weight and hence the melt index value of the resulting polymer can be adjusted. The target melt index of a polyoxymethylene copolymer can be between about 2 decigrams per minute (dg/min) and about 30 dg/min, between about 5 dg/min and about 20 dg/min, or between about 8 dg/min and about 10 dg/min.

### Plasticizer

The plasticizer is a substance incorporated into the copolymer before forming of thin sheets in any desired amount to control the degree of flexibility. The plasticizer reduces the melt viscosity and decreases the elastic modulus of the molded parts obtainable from the composition of the invention. The plasticizers which are useful for mixture herewith are organic substances with low vapor pressures, which physically adsorb causing molecular volume swelling with the components of the composition to form a homogeneous physical unit, whether it is by means of swelling or dissolving or any other. It has surprisingly found that an effective plasticizing effect could only be achieved in compositions which in addition to the polyoxymethylene (A) comprise at least one impact modifier (C), especially a thermoplastic elastomer.

Preferably the plasticizer has a molecular weight ranging from 100 to 1000, more preferably 120 to 800 and especially 150 to 600 g/mol. However, in case of polymeric plasticizers, preferably polyesters, an average molecular weight ranging from 800 to 10000 g/mol is preferred. Especially preferred are polyesters having an average molecular weight ranging from 1000 to 7000 g/mol.

Further preferred are plasticizers having a melting point of less than 200° C., preferably less than 180° C. Especially preferred are plasticizers which are liquid or have a solid amorphous phase within the range of −20° C. to 100° C.

According to a preferred embodiment the plasticizer is selected from the group consisting of aromatic esters, aromatic polyesters, aliphatic diesters, epoxides, sulfonamides, glycols, polyethers, polybutenes, polyesters, acetylated monoglycerides, alkyl citrates and organophosphates and mixtures thereof.

Preference is given to plasticizers which comprise an ester functionality. Therefore according to a preferred embodiment the plasticizer is selected from the group consisting of adipates, sebacates, maleates, phthalates, trimellitates, benzoates and mixtures thereof.

Examples of suitable phthalates are diisobutyl phthalate (DIBP), dibutyl phthalate (DBP), diisoheptyl phthalate (DIHP), L 79 phthalate, L711 phthalate, dioctyl phthalate, diisooctyl phthalate, dinonyl phthalate, diisononyl phthalate, diisodecyl phthalate, L911 phthalate, diundecyl phthalate, diisoundecyl phthalate, undecyl dodecyl phthalate, diisotridecyl phthalate (DTDP) and butyl benzyl phthalate (BBP).

Examples of adipates are dioctyl adipate, diisononyl adipate and diisodecyl adipate. An example for a trimellitate is trioctyl trimellitate. Phospate esters can also be used. Suitable examples are tri-2-ethylhexyl phosphate, 2-Ethylhexyl diphenyl phosphate and tricresyl phosphate.

Preferred sebacates and azelates are di-2-ethylhexyl sebacate (DOS) and di-2-ethylhexyl azelate (DOZ).

Preferred polyester plasticizers are typically based on condensation products of propane- or butanediols with adipic acid or phthalic anhydride. The growing polymer chain of these polyesters may then be end-capped with an alcohol or a monobasic acid, although non-end-capped polyesters can be produced by strict control of the reaction stoichiometry.

Further preferred plasticizers are benzoates which are commercially available as Jayflex® MB10, Benzoflex® 2088, Benzoflex® LA-705, Benzoflex® 9-88. Epoxide based plasticizer are preferably epoxidized vegetable oils.

Especially preferred plasticizers are aromatic benzene sulfonamides. Preference is given to benzene sulfonamides represented by the general formula (I)

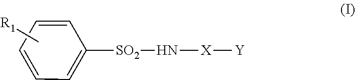

in which R1 represents a hydrogen atom, a C1-C4 alkyl group or a C1-C4 alkoxy group, X represents a linear or branched C2-C10 alkylene group, or a cycloaliphatic group, or an aromatic

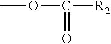

group, V represents one of the groups OH or _{w}here R2 represents a C1-C4 alkyl group or an aromatic group, these groups optionally themselves being substituted by an OH or C1-C4 alkyl group.

The preferred aromatic benzenesulphonamides of formula (I) are those in which: R1 represents a hydrogen atom or a methyl or methoxy group, X represents a linear or branched C2-C10 alkylene group or a phenyl group, Y represents an OH or —O—CO—R2 group, R2 representing a methyl or phenyl group, the latter being themselves optionally substituted by an OH or methyl group.

Mention may be made, among the preferred aromatic sulphonamides of formula (I) which are liquid (L) or solid (S) at room temperature as specified below, of the following products, with the abbreviations which have been assigned to them:
N-(2-hydroxyethypbenzenesulphonarnide (L), N-(3-hydroxypropyl)benzenesulphonamide (L),
N-(2-hydroxyethyl)-p-toluenesulphonamide (S), N-(4-hydroxyphenyl)benzenesulphonamide (5),
N-[(2-hydroxy-1-hydroxymethyl-1-methyl)ethyl]benzenesulphonamide (L),
N45-hydroxy-1,5-dimethylhexyl[benzenesulphonamide (S), N-(2-acetoxyethyl)benzenesulphonamide (5), N-(5-hydroxypentyl)benzenesulphonamide (L), N-[2-(4-hydroxybenzoyloxy)ethyl]benzene-sulphonamide (5), N-[2-(4-methylbenzoyloxy)ethyl]benzenesulphonamide (5), N-(2-hydroxyethyl)-p-methoxybenzenesulphonamide (S) and N-(2-hydroxypropyl)benzenesulphonamide (L).

The molecular weight and volatility of sulphonamides enables processing at high temperature without them substantially evaporating, which prevents losses of the product and atmospheric pollution; they do not decompose at high temperature, which prevents unacceptable coloring of the polymer and allows them to act as plasticizer since they remain present intact in the polymer. It is consequently possible henceforth to use these plasticizers for processing techniques (injection molding, extrusion, extrusion blow-molding, rotational molding, and the like) at high temperatures and with long contact times, their high compatibility with the abovementioned polyoxymethylene copolymer also promotes the development of their plasticizing properties, their plasticizing effect is reflected by a large decrease in the mechanical torque in processing, which represents a large decrease in the energy to be used during these operations; the plasticizing effect is also reflected by a fall in the glass transition temperature, which results in a decrease in the stiffness of the articles obtained starting with these compositions, which can be measured by the fall in the elastic modulus and by an improvement in the impact strength.

An especially preferred plasticizer is a sulfonamide, for example N-(n-butyl) benzene sulfonamide.

The plasticizer is present in the composition preferably in an amount up to 40 wt.-%, further preferably in an amount ranging from 2 to 30 wt.-%, more preferably ranging from 5 to 20 wt.-%, most preferably ranging from 8 to 18 wt.-%, wherein the weight is based on the total weight of the composition.

Inorganic filler

A suitable inorganic filler is one which absorbs plasticizer. A precipitated-, hydrated- or hydrogel-silica such as is commercially available, for example, from PPG Corporation under the trademark Hi Sil 233® . Instead of silica hydrogel or precipitated hydrated silica, the filler material can be any other relatively insoluble, inorganic solid capable of holding at least 30 wt. parts of plasticizer or other volatile matter per 100 wt. parts non-volatile material and be capable of releasing such volatile matter upon heating to an appropriate temperature of the polyacetal copolymer used in the process. In this manner, dehydration or devolatilization and shrinkage of the filler material in the semi-rigid deplasticized polyacetal copolymer sheet brings about the formation of the desired system of micropores within the sheet. Among the more readily available filler materials capable of meeting the foregoing requirements are aluminum hydroxide, ferrous hydroxide, hydrated absorbent clays or diatomaceous earths, borax and acetyl salisylic acid. Preferably the filler is selected so as to exhibit a controlled level of extraction depending on the flexural modulus desired in the extruded or calendered plastic sheet during the solvent removal phase of the process.

The solvent employed for the extraction steps should have an appreciable solvating or plasticizing action on polyacetal copolymer and should be capable of being readily absorbed by the filler material (e.g., silica). In general, organic solvents are preferred. Typical organic solvents which can be suitably employed include hexafloroisopropanol, methanol, acetone, ethers, dimethyl formamide, orthoclorobenzene, nitrobenzene, tetrahydrofuran and such ketones as methyl cyclohexanone, methyl ethyl ketone, and methyl isopropyl ketone. Cyclohexanone is a particularly preferred solvent since it is capable of properly plasticizing polyvinyl chloride and is only slightly soluble in water. Moreover, it has the capacity of being readily absorbed by silica and has a sufficiently high boiling point allowing for plasticization and extraction at temperatures above room temperature.

The amount of the polyoxymethylene copolymer present in formulations which are formed into films can vary depending on the desired filler and plasticizer content. In one embodiment, for instance, the composition contains the polyoxymethylene copolymer in an amount of at least about 40% by weight, such as in an amount greater than about 60% by weight, such as in an amount greater than about 65% by weight, such as in an amount greater than about 70% by weight. In general, the polyoxymethylene copolymer is present in an amount less than about 95% by weight, such as in an amount less than about 90% by weight, such as in an amount less than about 85% by weight.

As described above, a polyoxymethylene polymer having functional terminal groups has been found to have improved adhesive strength between the polymer film and inks, coatings, and the like. In addition to using the preferred polyoxymethylene copolymer containing functional terminal groups, the films may further include one or more functional additives. The functional additives can be present in the composition in order to alter one or more properties of the polyoxymethylene polymer film. The functional additive, for instance, may be included in the composition in order to lower the stiffness of the polyoxymethylene copolymer film. Reducing the modulus of elasticity can promote resistance to coating cracking and flaking off.

Functional additives that may be incorporated into the polyoxymethylene copolymer fims when compounding composition generally include lower melting point polymers. The polymers, for instance, can have a melting point generally less than 210° C., such as from about 90° C. to about 200° C. In one embodiment, for instance, a functional polymer may be selected that has a melting point of from about 150° C. to about 200° C. In addition, the functional additive may also be comprised of polar molecules. In one embodiment, for instance, the functional additive has greater polarity and functionality than the polyoxymethylene polymer. The functional additive selected, however, should also still allow for the composition to be ground into a powder having the appropriate particle size distribution and should not substantially degrade the resistance of the polyoxymethylene polymer to hot water and alkaline chemistries.

Functional additives that may be incorporated into the polymer composition, for instance, include thermoplastic elastomers, lower melting point polyamides, polyamide terpolymers, polyamide copolymers, ionomers, and mixtures thereof. In addition, the composition may optionally include one or more coupling agents. A coupling agent may be included in the composition in order to couple at least one functional additive to the polyoxymethylene polymer. In this regard, functional additives may also be selected that form an attachment with the polyoxymethylene polymer through covalent bonds, grafting, ionic bonds, or through any suitable linking mechanism.

In general, the one or more functional additives if used may generally be present in the polyoxymethylene copolymer composition in an amount from about 5% to about 50% by weight. In one embodiment, for instance, the functional additives may be present in the composition in an amount from about 10% to about 30% by weight.

As described above, one type of functional additive that may be included in the polymer composition is a thermoplastic elastomer. In one embodiment, the thermoplastic elastomer may include reactive groups that directly or indirectly attach to reactive groups contained on the polyoxymethylene polymer. For instance, in one embodiment, the thermoplastic elastomer may have active hydrogen atoms which allow for covalent bonds to form with the hydroxyl groups on the polyoxymethylene polymer when a coupling agent is employed.

Thermoplastic elastomers are materials with both thermoplastic and elastomeric properties.

Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE E), thermoplastic polyamide elastomers (TPE A) and in particular thermoplastic polyurethane elastomers (TPE-U). The above thermoplastic elastomers have active hydrogen atoms which can be reacted with the coupling reagents and/or the polyoxymethylene polymer. Examples of such groups are urethane groups, amido groups, amino groups or hydroxyl groups. For instance, terminal polyester diol flexible segments of thermoplastic polyurethane elastomers have hydrogen atoms which can react, for example, with isocyanate groups.

In one particular embodiment, a thermoplastic polyurethane elastomer is used as the functional additive either alone or in combination with other functional additives. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, poly(ethylene adipate)diol and poly(E-caprolactone)diol; and polyether diols such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C2-C6 aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocya nate).

In general, the thermoplastic elastomer may be present in the composition in the amounts described above. In one embodiment, for instance, the thermoplastic elastomer may be present in the composition in an amount greater than about 10% by weight and in an amount less than about 30% by weight. For instance, the thermoplastic elastomer may be present in an amount from about 15% to about 25% by weight.

The “POM polymers” which can be used as polyoxymethylene (A) generally have a melt volume rate MVR (also referred to as M.I.) of 0.5 to 3 cm3 /10 min, preferably ranging from 1 to 2 cm3 /10 min, more preferably ranging from 1 to 2 cm3 /10 min and especially about 1 cm3 /10 min according to ISO 1133 at 190 ° C. and 2.16 kg load.

Preferably, polyoxymethylene (A) has a content of terminal hydroxyl groups of at least 5 mmol/kg, preferably at least 10 mmol/kg, more preferably at least 15 mmol/kg and most preferably ranging from 15 to 50 mmol/kg, especially 18 to 40 mmol/kg. The content of terminal hydroxyl groups can be determined as described in K. Kawaguchi, E. Masuda, Y. Tajima, Journal of Applied Polymer Science, Vol. 107, 667-673 (2008).

The preparation of the polyoxymethylene (A) can be carried out by polymerization of polyoxymethylene-forming monomers, such as trioxane or a mixture of trioxane and dioxolane and/or butandiol formal in the presence of a molecular weight regulator such as ethylene glycol or methylal. The polymerization can be effected as precipitation polymerization or in particular in the melt. Initiators which may be used are the compounds known per se, such as trifluoromethane sulfonic acid, these preferably being added as solution in ethylene glycol to the monomer. The procedure and termination of the polymerization and working-up of the product obtained can be effected according to processes known per se. By a suitable choice of the polymerization parameters, such as duration of polymerization or amount of molecular weight regulator, the molecular weight and hence the MVR value of the resulting polymer can be adjusted.

The solvent employed should have an appreciable solvating or plasticizing action on the resinous binder (e.g., the polyvinyl chloride) and should be capable of being readily absorbed by the filler material (e.g., silica). In general, organic solvents are preferred. Typical organic solvenₜs which can be suitably employed include acetone, ethers, dimethyl formannide, orthoclorobenzene, nitrobenzene, tetrahydrofuran and such ketones as methyl cyclohexanone, methyl ethyl ketone, and methyl isopropyl ketone. Cyclohexanone is a particularly preferred solvent since it is capable of properly plasticizing polyvinyl chloride and is only slightly soluble in water. Moreover, it has the capacity of being readily absorbed by silica and has a sufficiently high boiling point allowing for plasticization and extraction at temperatures above room temperature.

### Microporous Film Formation Steps

One method for producing a microporous polyacetal copolymer sheet comprises:
(a) forming a sheet from a mixture comprising linear polyacetal copolymer having a M. I. of from 0.5 to 3.5, and a finely divided particulate inorganic, water-insoluble filler, the weight ratio of said filler to polymer in the mixture being in the range of from about 1:1 to about 9:1, and a plasticizer;
(b) removing a portion of the plasticizer by treating the film with a solvent, resulting in network of interconnecting pores communicating throughout the microporous material, said pores constituting from about 35 percent to about 80 percent by volume of the microporous sheet;
(c) removing the solvent and
(d) stretching the microporous sheet in at least one stretching direction to a stretch ratio of at least about 1.2 times its initial length.

Another method for forming a microporous film comprises the following steps:
a. forming the composition comprising the mixture of a polyacetal copolymer, an inorganic filler, and a plasticizer;
b. extruding or molding said composition at an elevated temperature or above to form a substantially flattened sheet;
c. passing said flattened sheet through an extraction medium to remove a portion of the plasticizer and
d. removing said extraction medium from said sheet.

### Uses of the Microporous Film

The microporous film can be a thin sheet, film, or tube having a thickness across the microporous material in the range of from about 0.03 to about 0.7 millimeter, and in this form it exhibits flexibility or rigidity as desired in its material composition. In addition to being ereadlily printed or coated with a variety of conventional inks, and coatings, the microporous film exhibits a high moisture vapor transmission rate, ie, breathability, while resisting the transmission of liquid water and aqueous solutions, and it is suitable for use in, for example, breathable water proof garments, gloves, shoes, tents, and absorptive products such as wipers, diapers, incontinence devices, sanitary napkins and the like, where such properties are desirable. Even when the thickness of the microporous material is substantially greater than 0.25 millimeter, it has utility as a filter medium, substrate for protein immobilization, substrate for the slow release of medicaments or perfumes, and a multitude of other uses. In the thin form it is an especially useful material from which the petals of artificial flowers may be made.

1. A method for forming a microporous film comprising the following steps:
a. forming the composition comprising the mixture of a polyacetal copolymer, an inorganic filler, and a plasticizer;
b. extruding or molding said composition at an elevated temperature or above to form a substantially flattened sheet;
c. passing said flattened sheet through an extraction medium to remove a portion of the plasticizer and
d. removing said extraction medium from said sheet.

2. A method for forming a microporous polyacetal copolymer sheet comprising:
(a) forming a sheet from a mixture comprising linear polyacetal copolymer having a M. I. of from 0.5 to 3.5, and a finely divided particulate inorganic, water-insoluble filler, the weight ratio of said filler to polymer in the mixture being in the range of from about 1:1 to about 9:1, and a plasticizer;
(b) removing a portion of the plasticizer by treating the film with a solvent, resulting in network of interconnecting pores communicating throughout the microporous material, said pores constituting from about 35 percent to about 80 percent by volume of the microporous sheet;
(c) removing the solvent and
(d) stretching the microporous sheet in at least one stretching direction to a stretch ratio of at least about 1.2 times its initial length.
